(19) United States
(12) Patent Application Publication
(10) Pub. No.: US 2005/0277506 A1
(43) Pub. Date: Dec. 15, 2005

(54) Synthetic resin guide

(75) Inventor: Masahiko Konno, Osaka (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: Tsubakimoto Chain Co., Osaka (JP)

(21) Appl. No.: 11/093,691

(22) Filed: Mar. 30, 2005

(30) Foreign Application Priority Data
Jun. 15, 2004 (JP) 2004-177490

(51) Int. Cl. F16H 7/08

(52) U.S. Cl. 474/111

(57) ABSTRACT

A synthetic resin guide for a transmission device comprises an integrally molded, synthetic resin guide body having a shoe with a front surface for sliding contact with a chain, and a support on its back surface, the support having a longitudinal slot, formed between two opposed walls, for receiving a reinforcing plate. Both the guide body and the plate having mounting holes that are coaxial when the plate is incorporated into the guide body. A pressing member, integrally formed on one of the walls of the guide body, includes an eccentric head which uniformly presses against opposite parts of the edge of an opening of a positioning hole in the reinforcing plate.

### FIELD OF THE INVENTION

This invention relates to a synthetic resin guide for an endless, traveling, flexible, power transmission medium, such as a roller chain, a silent chain, or a toothed belt, used to transmit rotation from a driving sprocket to one or more driven sprockets in the valve timing drive of an internal combustion engine, for example.

### BACKGROUND OF THE INVENTION

In a timing transmission, the transmission medium, typically a chain, is in sliding engagement with a pivoted guide, serving as a tensioner lever in cooperation with a tensioner, on the slack side of the transmission, and in sliding engagement with a fixed guide on the tension side of the transmission. Both guides are typically composed of synthetic resin, and are attached to the frame of the engine by mounting bolts, pins, or the like, and not only maintain proper tension in the transmission medium, but also prevent vibration both in, and transverse to, the plane of movement of the transmission medium.

A conventional pivotable synthetic resin guide 500, for use as a tensioner lever, is shown in FIGS. 7 and 8. The guide comprises a molded, synthetic resin, guide body 510, having a shoe 511 with a chain-engaging surface on a front side thereof for sliding contact with a chain, and a shoe support 512, on the back side of the shoe opposite from the side on which the chain-engaging surface is formed. The shoe support 512 includes a pair of walls 512a, spaced from each other to provide between them a slot S, extending along the longitudinal direction of the guide, for receiving a reinforcing plate 520. A resilient pressing member 513, which is formed in one of the walls 512a as an integral part of the shoe support, protrudes through a cut-out part of the wall into the slot S, and includes a spherical head which engages a positioning hole 521 in the reinforcing plate. The shoe support is provided with a mounting hole 512b (FIG. 7) formed in a boss 512c adjacent one end of the guide. The mounting hole 512b receives a mounting member such as a pin or shoulder bolt (not shown), which protrudes from an engine body, and about which the guide is pivoted. The reinforcing plate has an insertion hole 522, which is aligned with the mounting hole 512b when the reinforcing plate is inserted in slot S. The structure of the conventional guide of FIGS. 7 and 8 is described and shown in U.S. published patent application 2003-0144100, dated Jul. 31, 2003.

In the molding of conventional synthetic resin guide 500, the molding accuracy of the guide body 510 can be impaired by non-uniformity in the cooling rate of the resin and thermal shrinkage. As a result, it may be difficult to align the insertion hole 522 in the reinforcing plate 520 with the mounting hole 512b in the guide body, and consequently it can become difficult to insert a mounting member such as a shoulder bolt or the like through the holes.

When the reinforcing plate 520 is incorporated into the guide body 510, the pressing member 513, when bent, may abuts the reinforcing plate 520 as shown in FIG. 8, with its spherical head 513a in contact with only a part of the edge of the positioning hole 521, so that a local gap X is formed, the resilient force exerted by the pressing member, while tending to close the gap X, causes the position of hole 522 of the reinforcing plate to shift relative to the mounting hole 512b, so that, when the assembly is mounted on a mounting member such as a shoulder bolt or the like, excessive insertion force is required. Moreover, when the assembly is mounted on the mounting member, the gap X reopens, and the gap allows vibration noise to be generated.

The object of this invention is to solve the above-mentioned problems, and to provide a synthetic resin guide in which the guide body and the reinforcing plate may be easily assembled, in which the holes of the guide body and the reinforcing plate are reliably aligned so that the guide can be easily mounted on a mounting pin or mounting bolt, and in which vibration noises due to a gap between the head of the pressing member and the positioning hole of the reinforcing plate can be avoided.

### BRIEF SUMMARY OF THE INVENTION

The synthetic resin guide in accordance with the invention comprises, as its principal elements an integrally molded, elongated, synthetic resin guide body and a reinforcing plate. The guide body comprises a shoe having a surface on a front side thereof for sliding engagement with a traveling, flexible, power transmission medium, and a support on the back side thereof comprising a pair of opposite walls with a longitudinal slot between them. A mounting hole, intersecting the slot, is formed in the walls adjacent one end of the guide body, and the reinforcing plate is inserted into the slot. The reinforcing plate has a mounting hole coaxially aligned with the mounting hole formed in the walls of the guide body. A positioning hole formed in the reinforcing plate, and the guide body includes a resilient pressing member, integrally molded with one of its walls, and positioned adjacent to the mounting holes. The pressing member comprises a resilient arm extending from a portion of the wall with which it is integrally molded toward the shoe, and a pressing head protruding from the arm toward the positioning hole of the reinforcing plate. The positioning hole has an edge defining an opening facing, and engageable by, the pressing head pressing member. This opening has a height measured from a first portion of the edge farthest from the shoe to a second portion of the edge nearest the shoe in a direction perpendicular to the nearest adjacent part of the sliding surface on the front side of the shoe. The pressing head has a lower surface engageable with the first portion of the edge of the positioning hole and an upper surface engageable with the second portion of the edge of the positioning hole. The pressing head, has an eccentric shape such that a tangent to its lower surface, intersecting the location at which the lower surface meets the arm, forms a first obtuse angle relative to the arm, and a tangent to its upper surface, intersecting the location at which the upper surface meets the arm forms a second obtuse angle relative to said arm, the first obtuse angle being greater than the second obtuse angle.

When the guide is fully assembled, the lower surface of the pressing head is in engagement with the first portion of the edge of the positioning hole, and the upper surface of the pressing head is in engagement with the second portion of the edge of the positioning hole, thereby eliminating a gap between the pressing head and the reinforcing plate that could allow vibration noise.

The pressing head is preferably larger than the positioning hole in the direction perpendicular to the nearest adjacent part of the sliding surface of the shoe. More specifically, the distance between the locations at which the upper and lower surfaces of the pressing head meet the arm is larger than the height of the positioning hole.

The eccentric pressing head is superior to the spherical pressing head of FIG. 8 because the difference between the angles of the upper and lower surfaces of the pressing head reduces the size of the gap X as shown in FIG. 8, or eliminates the gap entirely, even when distortion in the molding process causes the relative positions of the pressing head and the positioning hole of the guide body to deviate from their ideal relationship. If the pressing head is spherical, especially if the height of the pressing head is the same as the height of the positioning hole, warping of the pressing member upon insertion of the reinforcing plate occurs, and the pressure exerted by the pressing head on the plate may become inadequate. On the other hand, the different angles of the upper and lower parts of the pressing head in accordance with the invention enable the pressing head to exert adequate pressure on the reinforcing plate.

The invention is applicable not only to movable synthetic resin guides used as tensioner levers, but also fixed guides and other forms of movable guides for power transmitting media such as roller chains, silent chains or the like.

Various resin materials may be used as the synthetic resin of the guide body. However, preferred material include Nylon 6, Nylon 66, and Nylon 46, as well as all aromatic Nylons known as engineering plastics. These materials exhibit excellent wear resistance and lubricity, and are capable of functioning wall as shoes for sliding contact with a power transmitting medium. If bending rigidity, toughness and strength are required, fiber-reinforced plastics are preferably used.

The reinforcing plate likewise can be composed of any of a wide variety of materials. However, iron-based metal, non-ferrous metals such as aluminum, magnesium, titanium and the like, engineering plastics, fiber-reinforced plastics and the like having excellent bending rigidity and strength are preferred. Furthermore, the reinforcing plate can be provided in any of a wide variety of shapes. For example, a reinforcing plate having one or more weight-reducing windows may be used.

The holes for receiving a mounting member, in the guide body and the reinforcing plate, can be of different sizes. For example the diameter of the hole in the reinforcing plate can be larger than the diameter of the hole in the guide body so that the axes of the holes can be slightly misaligned without making it more difficult to fit the assembly to a mounting member such as a shoulder bolt projecting from an engine block. Additionally, by increasing dimensional tolerance in this manner, a reduced requirement for guide molding accuracy can be realized.

The reinforced guide is able to apply proper tension to a traveling power transmission medium and thereby achieve stable operation without side run-out or vibration either in, or transverse to, the plane of movement of the transmission medium.

Since the pressing member uniformly engages and presses against a positioning hole formed in the reinforcing plate, the synthetic resin guide body and the reinforcing plate can be easily assembled without the need for additional parts. Moreover, because the mounting holes of the guide body and the reinforcing plate are reliably positioned in coaxial relationship, the assembly can be easily mounted on a mounting member without the need to adjust the relationship between these holes.

Furthermore, since the diameter of the pressing head is larger than the diameter of the positioning hole, even if the pressing member is warped, the pressing head will uniformly press the reinforcing plate without biased contact with the positioning hole of the reinforcing plate. No gap is produced between the pressing head and the positioning hole of the reinforcing plate, and consequently, vibration noise due to such a gap is avoided.

### BRIEF DESCRIPTION OF THE DRAWINGS

FIG. 1 is an exploded view of a synthetic resin guide in accordance with a first embodiment of the invention, showing the reinforcing plate separated from the synthetic resin guide body;

FIG. 2 is a cross-sectional view through the assembled guide, illustrating how the reinforcing plate is held in place by a resilient pressing member formed as a part of the guide body;

FIG. 3 is an enlarged, fragmentary, cross-sectional view showing the head portion of the pressing member;

FIG. 4 is a cross-sectional view, similar to FIG. 2, showing the relationship between the head portion of the pressing member and a positioning hole in the reinforcing plate;

FIG. 5 is a perspective view of the head portion of the pressing member;

FIG. 6 is a perspective view, similar to FIG. 5, showing a modification of the pressing member;

FIG. 7 is an exploded view of a conventional synthetic resin guide; and

FIG. 8 is a cross-sectional view through an assembled conventional synthetic resin guide.

### DETAILED DESCRIPTION OF THE PREFERRED EMBODIMENTS

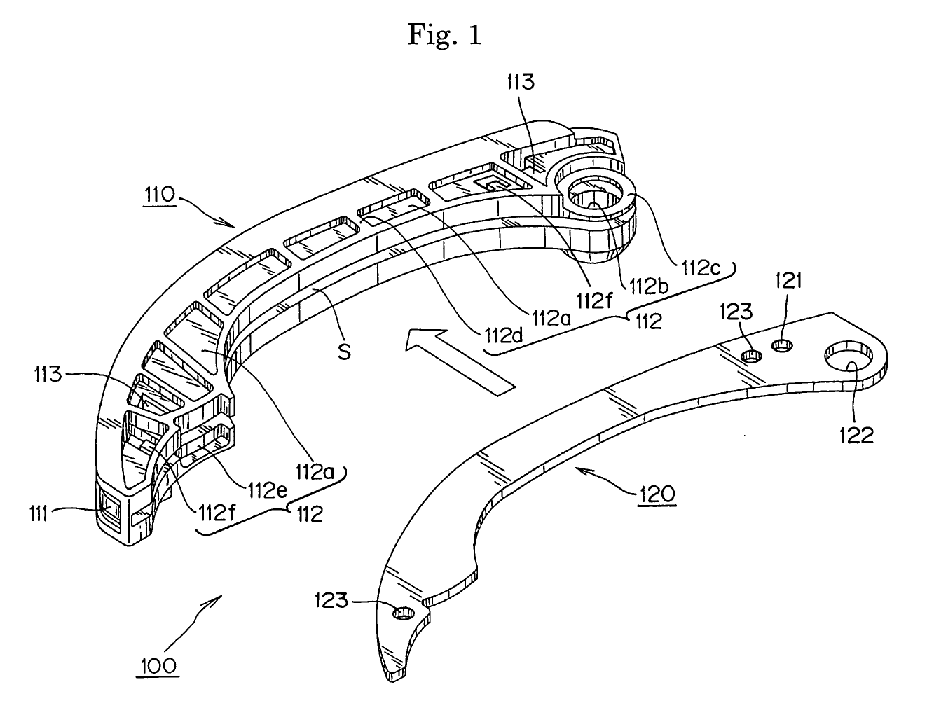

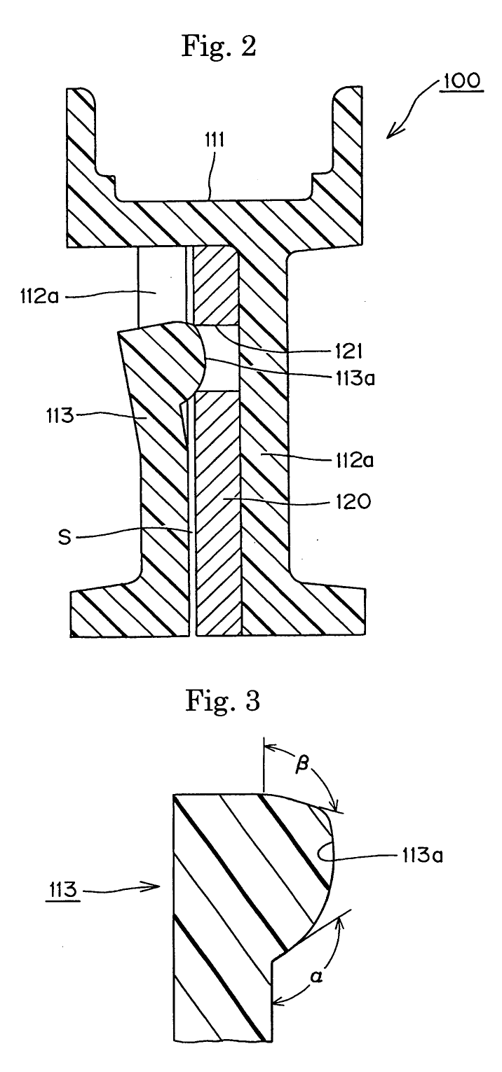

A synthetic resin guide 100, in accordance with the invention, is shown in FIGS. 1 and 2. This guide is designed to serve as a tensioner lever, controlling tension in a chain with which it is in sliding engagement by pivoting against the chain about a mounting member such as a shoulder bolt (not shown) extending from an engine block. The guide is preferably a two-part structure comprising an integrally molded, synthetic resin guide body 110, and a reinforcing plate 120, which is preferably punched from a steel sheet. The reinforcing plate 120 is inserted into the guide body 110 in the direction of the arrow shown in FIG. 1.

The guide body 110 is composed of a shoe 111, with a chain-engaging surface on a front side thereof, and extending along the longitudinal direction of the guide, for sliding contact with a chain, and a shoe support 112, on the back side of the shoe opposite from the side on which the chain-engaging surface is formed. The shoe support 112 includes a pair of walls 112a, spaced from each other to provide between them a slot S, extending along the longitudinal direction of the guide, for receiving the reinforcing plate 120. A mounting hole 112b, for receiving a pin or bolt projecting from an engine body, is provided in the slot walls 112a adjacent one end of the guide. The guide body 110 is provided with a plurality of reinforcing ribs 112d, a tensioner contact portion 112e, and a plurality of tongues 112f, which engage the reinforcing plate 120. A resilient pressing member 113, which is formed in one of the walls 112a as an integral part of the shoe support, protrudes through a cut-out part of the wall into the slot S, and includes a head 113a (FIG. 2), for engagement with a positioning hole 121 in the reinforcing plate.

The head portion 113a uniformly presses against the positioning hole 121 in the reinforcing plate 120 as shown in FIG. 2, so that the reinforcing plate 120 is held between the pressing member 113 and the opposite slot wall 112a, even if the width of the slot S is larger than the width of the reinforcing plate. The resilient pressing force exerted by the pressing member against the reinforcing plate 120, reliably holds the reinforcing plate in the guide body 110.

The head 113a of the pressing member 113 protrudes from the rectangular body portion of the pressing member, and is shaped so that a tangent to the part of the head farthest from the shoe 111, that is, the lower part as seen in FIG. 3, forms an obtuse angle α with the face of the rectangular body portion from which the head protrudes. A tangent to the part of the head nearest the shoe 111, that is, the upper part as seen in FIG. 3, forms an obtuse angle β with the face of the rectangular body portion, the angle α being larger than the angle β. As a result of the difference between these angles, the upper part of the pressing head has a gradual slope where it engages the edge of the opening of the positioning hole 121, whereas the lower part of the pressing head has a steeper slope where it engages the edge of the pressing head. Because of the more gradual angle at the upper surface of the pressing head, when the pressing head enters the positioning hole, the reinforcing plate is held more firmly. As shown in FIG. 2, the head 113a uniformly presses against the positioning hole 121 of the reinforcing plate 120 so that the mounting hole 112b of the guide body 110 and the insertion hole 122 of the reinforcing plate 120, which is fastened together with the engine body mounting hole 112b, do not significantly shift relative to each other, and reliably remain positioned in coaxial relationship. As a result, it is easy to place the assembled guide on a mounting member protruding from an engine block by moving the assembled guide so that the mounting member extends through holes 112b and 122.

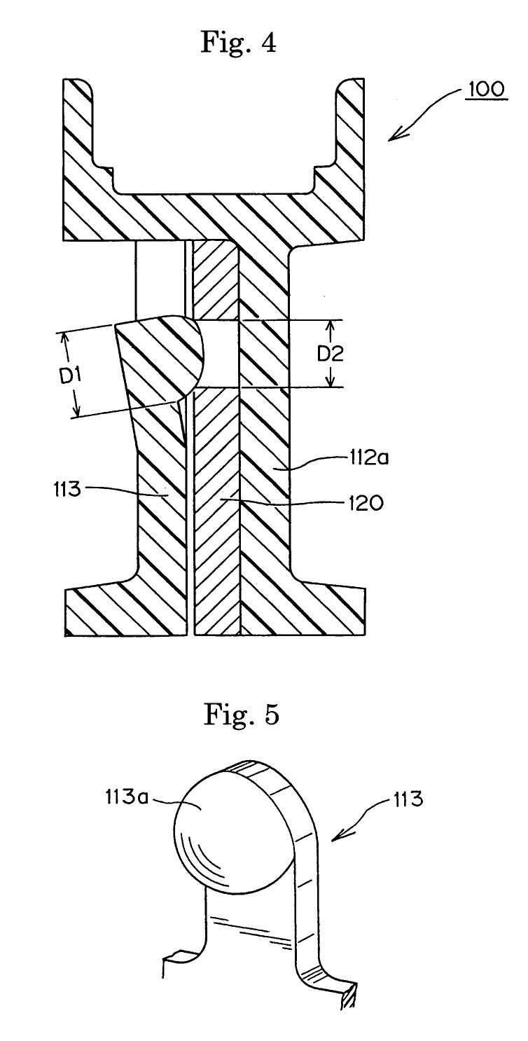

As shown in FIG. 4, the diameter D1 of the head 113a is larger than the diameter D2 of the positioning hole 121. Thus, when the reinforcing plate 120 is incorporated into the synthetic resin guide body 110, even if the pressing member 113 is warped, the head 113a presses against the edge of the positioning hole 121 in the reinforcing plate 120 without biased contact. Accordingly, no gap is generated between the head 113a and the positioning hole 121, and vibration noise, which would result if a gap were present, is avoided.

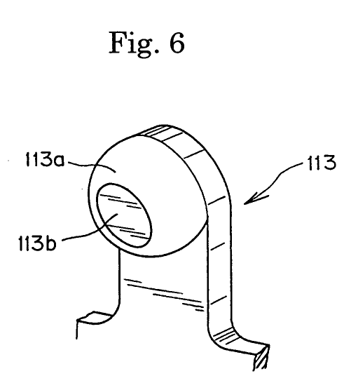

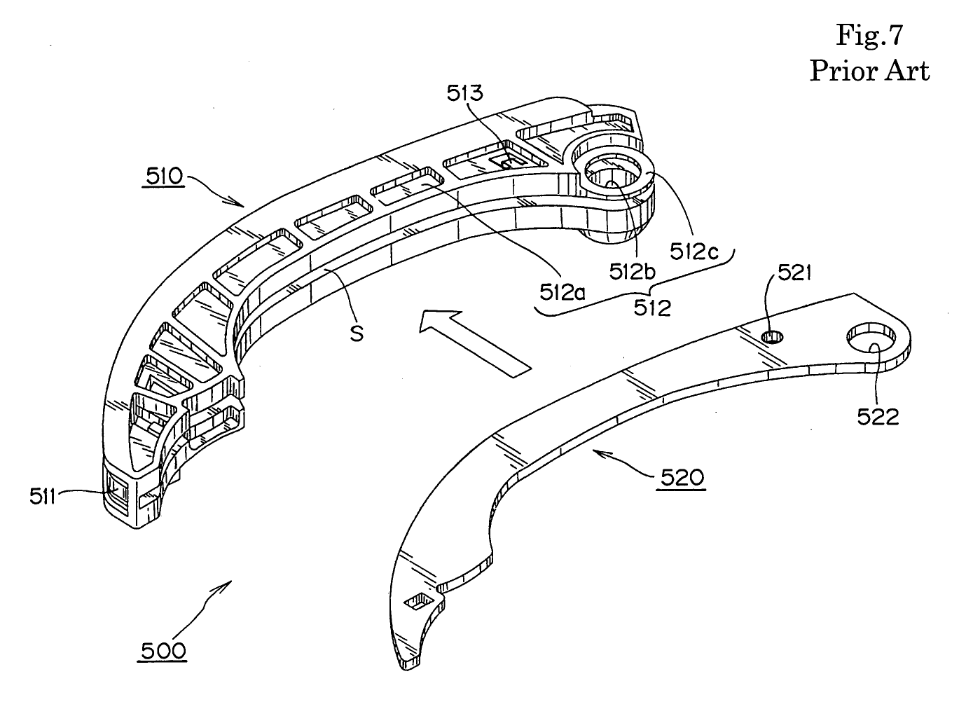

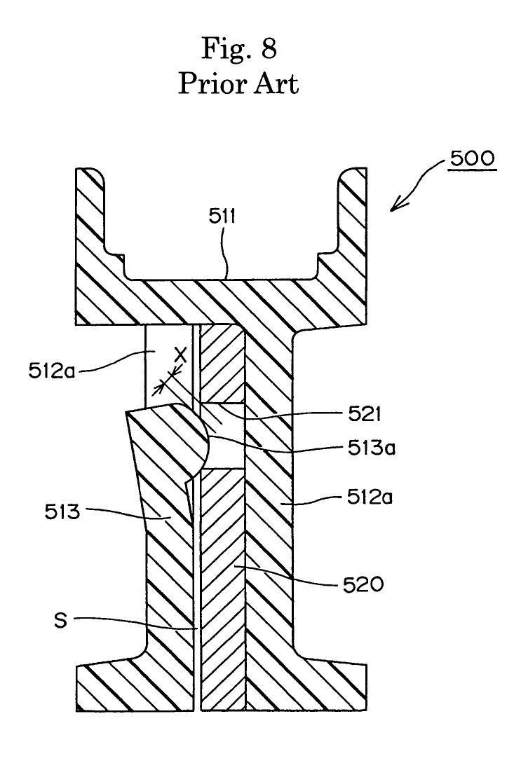

Although FIG. 5 shows a rounded head 113a, which, although shaped eccentrically, is nearly spherical, a flat surface 113b may be formed on the head 113a, as shown in FIG. 6, in order to make it easier to incorporate the reinforcing plate 120 into the guide body 110.

As shown in FIG. 1, the reinforcing plate 120 reinforces the synthetic resin guide body 110, and includes a positioning hole 121, which is engaged by the head 113a of the pressing member 113, so that the mounting hole 122 of the reinforcing plate and the mounting hole 112b of the guide body 110 can be mounted on a mounting member such as a shoulder bolt. The reinforcing plate also has locking holes 123 near its opposite ends, which are engaged by tongues 112f formed in the guide body to lock the reinforcing plate in place. Consequently, when the guide is mounted on the engine body, the reinforcing plate 120 does not become disengaged from the guide body 110. A tensioner contact portion 112e, is engageable by the plunger of a tensioner (not shown) mounted on the engine body, in order to control chain tension.

Since the pressing member 113 is integrally molded to a wall 112a adjacent the boss 112c, and includes a head 113a, which uniformly presses against the positioning hole 121 of the reinforcing plate 120, the guide body and reinforcing plate can be easily assembled in such a way that the mounting holes 112b and 122 are reliably positioned in coaxial relationship to receive a mounting member. The head 113a has a shape in which the angle α at the proximal end is larger than the angle β at the distal end, and uniformly presses against the positioning hole 121 of the reinforcing plate 120, and the diameter D1 of the spherical pressing head portion is larger than the diameter D2 of the positioning hole 121. Therefore, even if the pressing head 113a engages the positioning hole by first contacting the upper part of the edge of the hole and then contacting the lower part of the edge of the hole, any warping that occurs upon insertion of the reinforcing plate does not prevent the pressing head from uniformly contacting the upper and lower parts of the edges of the positioning hole. Therefore, the pressing head does not contact the positioning hole 121 of the reinforcing plate 120 in a biased manner. No gap is formed between the head 113a and the positioning hole 121, and vibration noise is avoided.

1. A synthetic resin guide for a transmission device comprising: an integrally molded, elongated, synthetic resin guide body comprising a shoe having a surface on a front side thereof for sliding engagement with a traveling, flexible, power transmission medium, and a support on the back side thereof comprising a pair of opposite walls with a longitudinal slot between them, a mounting hole formed in said walls adjacent one end of the guide body the mounting hole intersecting the slot, and a reinforcing plate inserted into said slot and having a mounting hole coaxially aligned with the mounting hole formed in said walls of the guide body, and a positioning hole formed in said reinforcing plate, the guide body including a resilient pressing member integrally molded with one of said walls and positioned adjacent to said mounting holes, wherein said pressing member comprises a resilient arm extending from a portion of said one of said walls toward said shoe, and a pressing head protruding from said arm toward said positioning hole, wherein said positioning hole has an edge defining an opening facing, and engageable by, said pressing head pressing member, said opening having a height measured from a first portion of said edge farthest from the shoe to a second portion of said edge nearest the shoe in a direction perpendicular to the nearest adjacent part of said surface on the front side of the shoe, and wherein said pressing head has a lower surface engageable with said first portion of the edge of the positioning hole and an upper surface engageable with a second portion of the edge of the positioning hole, and wherein a tangent to said lower surface, intersecting the location at which said lower surface meets said arm forms a first obtuse angle relative to said arm, and a tangent to said upper surface, intersecting the location at which said upper surface meets said arm forms a second obtuse angle relative to said arm, said first angle being greater than said second angle.

2. A synthetic resin guide according to claim 1, in which said lower surface of the pressing head is in engagement with said first portion of said edge of the positioning hole, and said upper surface of the pressing head is in engagement with said second portion of said edge of the positioning hole.

3. A synthetic resin guide for a transmission device according to claim 1, in which the distance between said locations at which the upper and lower surfaces of the pressing head meet said arm is larger than said height of said positioning hole.
